(19) United States
(12) Patent Application Publication
(10) Pub. No.: US 2020/0105156 A1
(43) Pub. Date: Apr. 2, 2020

(54) ADAPTIVE INTERVIEW PREPARATION FOR CANDIDATES

(71) Applicant: Microsoft Technology Licensing, LLC, Redmond, WA (US)

(72) Inventors: Karthik Dundee Jayachandar Naidu, Mountain View, CA (US); Himanshu Khurana, Millbrae, CA (US); Vijay Ramamurthy, San Jose, CA (US); Rohan Ramanath, Saratoga, CA (US); Vasudeva Nagaraja, San Jose, CA (US); Berardino F. Pezzuti, San Jose, CA (US); Joseph Addona, Sunnyvale, CA (US); Jefferson Lai, San Jose, CA (US); Xixi Xiao, Milpitas, CA (US); Kyle W. Liu, Palo Alto, CA (US); David L. Ding, Sunnyvale, CA (US); Marcos Vinicius V Santanna, Campbell, CA (US); Richard G. Cook, San Jose, CA (US); Min Lu, Santa Clara, CA (US)

(73) Assignee: Microsoft Technology Licensing, LLC, Redmond, WA (US)

(21) Appl. No.: 16/146,829

(22) Filed: Sep. 28, 2018

(51) Int. Cl. G09B 7/06; G06F 17/30; G06N 7/08; G06F 15/18

(52) U.S. Cl. CPC G09B 7/06; G06F 17/30654; G06F 15/18; G06N 7/08; G06F 17/30616

(57) ABSTRACT

The disclosed embodiments provide a system for performing adaptive interview preparation for candidates. During operation, the system obtains a graph-based representation of potential questions for a candidate during an interview. Next, the system receives an answer by the candidate to a first question included in the graph-based representation. The system then calculates similarities between the answer and a set of sample answers to the first question. Finally, the system selects a second question for presentation to the candidate in the interview based on a highest similarity of the answer to a sample answer in the set of sample answers and an edge between the first and second questions in the graph-based representation. The system further triggers presentation of the selected second question to the candidate.

### BACKGROUND

### Field

The disclosed embodiments relate to screening of candidates. More specifically, the disclosed embodiments relate to techniques for performing adaptive interview preparation for candidates.

### Related Art

Online networks may include nodes representing individuals and/or organizations, along with links between pairs of nodes that represent different types and/or levels of social familiarity between the entities represented by the nodes. For example, two nodes in an online network may be connected as friends, acquaintances, family members, classmates, and/or professional contacts. Online networks may further be tracked and/or maintained on web-based networking services, such as online networks that allow the individuals and/or organizations to establish and maintain professional connections, list work and community experience, endorse and/or recommend one another, promote products and/or services, and/or search and apply for jobs.

In turn, online networks may facilitate activities related to business, recruiting, networking, professional growth, and/or career development. For example, professionals may use an online network to locate prospects, maintain a professional image, establish and maintain relationships, and/or engage with other individuals and organizations. Similarly, recruiters may use the online network to search for candidates for job opportunities and/or open positions. At the same time, job seekers may use the online network to enhance their professional reputations, conduct job searches, reach out to connections for job opportunities, and apply to job listings. Consequently, use of online networks may be increased by improving the data and features that can be accessed through the online networks.

### BRIEF DESCRIPTION OF THE FIGURES

FIG. 1 shows a schematic of a system in accordance with the disclosed embodiments.

FIG. 2 shows a system for performing adaptive interview preparation for a candidate in accordance with the disclosed embodiments.

FIG. 3 shows a flowchart illustrating a process of performing adaptive interview preparation for a candidate in accordance with the disclosed embodiments.

FIG. 4 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

### Overview

The disclosed embodiments provide a method, apparatus, and system for performing interview preparation for candidates, such as candidates for jobs, positions, roles, and/or opportunities. During interview preparation, the candidates may provide answers to sample interview questions, receive tips and/or feedback on preparing for interviews, and/or view scores and/or feedback that reflects the candidates' performance on the interview questions.

More specifically, the disclosed embodiments provide a method, apparatus, and system for performing adaptive interview preparation, in which interview questions are selected for presentation to candidates based on the quality, content, correctness, and/or other attributes of the candidates' answers to previous interview questions. First, a graph-based representation of a set of interview questions is obtained. For example, a directed acyclic graph (DAG) may be used to model multiple possible paths and/or combinations of questions that a candidate may encounter in a given interview.

Next, the graph-based representation and the candidate's answers to previous questions in the interview are used to select subsequent questions for presentation to the candidate. For example, similarities between the candidate's answer to a question and sample answers to the question may be calculated and used to identify an edge between the question and another question in the graph-based representation that reflects the highest similarity between the candidate's answer and a sample answer. The other question may then be presented to the candidate as the next question in the interview. In turn, the next question may represent a “follow up” question that addresses the content of the candidate's answer and/or a question that is selected to reflect the candidate's ability level.

In another example, the candidate's answer to a multiple-choice answer question may be matched to a corresponding child node of the question in the graph-based representation, and the question represented by the child node may be selected as the next question for the candidate. In a third example, a score representing a correctness of the candidate's answer to a question may be calculated, and a child node of the question may be selected as the next question for the candidate based on the correctness.

By adapting subsequent interview questions based on answers submitted by candidates for previous interview questions, the disclosed embodiments may allow the candidates to practice interviewing at a level that fits the candidates' abilities and/or knowledge instead of at a level that is too hard or too easy. At the same time, the candidates may encounter new combinations of questions as the candidates retry the same practice interviews, which may improve the candidates' interviewing abilities and/or related skills and expose the candidates to different types of questions. In contrast, conventional interview preparation techniques may require all candidates to answer the same set of questions in a given practice interview and/or may select follow-up questions that are not based on the candidates' answers to previous questions. Consequently, the disclosed embodiments may improve the effectiveness, performance, and/or user experience associated with applications, computer systems, and/or technologies for performing interview preparation, candidate screening, recruiting, hiring, and/or assessment.

### Adaptive Interview Preparation for Candidates

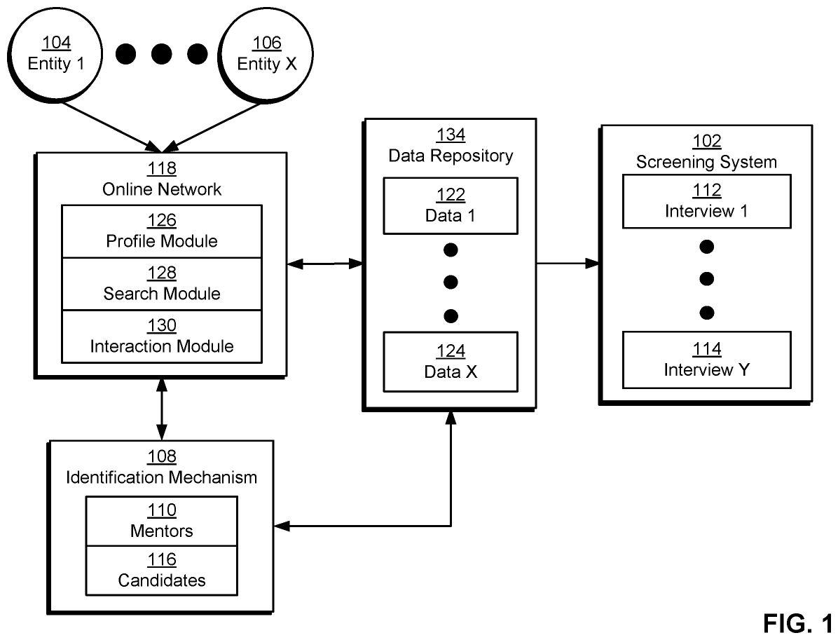

FIG. 1 shows a schematic of a system in accordance with the disclosed embodiments. As shown in FIG. 1, the system may include an online network 118 and/or other user community. For example, online network 118 may include an online professional network that is used by a set of entities (e.g., entity 1 104, entity x 106) to interact with one another in a professional and/or business context.

The entities may include users that use online network 118 to establish and maintain professional connections, list work and community experience, endorse and/or recommend one another, search and apply for jobs, and/or perform other actions. The entities may also include companies, employers, and/or recruiters that use online network 118 to list jobs, search for potential candidates, provide business-related updates to users, advertise, and/or take other action.

Online network 118 includes a profile module 126 that allows the entities to create and edit profiles containing information related to the entities' professional and/or industry backgrounds, experiences, summaries, job titles, projects, skills, and so on. Profile module 126 may also allow the entities to view the profiles of other entities in online network 118.

Profile module 126 may also include mechanisms for assisting the entities with profile completion. For example, profile module 126 may suggest industries, skills, companies, schools, publications, patents, certifications, and/or other types of attributes to the entities as potential additions to the entities' profiles. The suggestions may be based on predictions of missing fields, such as predicting an entity's industry based on other information in the entity's profile. The suggestions may also be used to correct existing fields, such as correcting the spelling of a company name in the profile. The suggestions may further be used to clarify existing attributes, such as changing the entity's title of “manager” to “engineering manager” based on the entity's work experience.

Online network 118 also includes a search module 128 that allows the entities to search online network 118 for people, companies, jobs, and/or other job- or business-related information. For example, the entities may input one or more keywords into a search bar to find profiles, job postings, job candidates, articles, and/or other information that includes and/or otherwise matches the keyword(s). The entities may additionally use an “Advanced Search” feature in online network 118 to search for profiles, jobs, and/or information by categories such as first name, last name, title, company, school, location, interests, relationship, skills, industry, groups, salary, experience level, etc.

Online network 118 further includes an interaction module 130 that allows the entities to interact with one another on online network 118. For example, interaction module 130 may allow an entity to add other entities as connections, follow other entities, send and receive emails or messages with other entities, join groups, and/or interact with (e.g., create, share, re-share, like, and/or comment on) posts from other entities.

Those skilled in the art will appreciate that online network 118 may include other components and/or modules. For example, online network 118 may include a homepage, landing page, and/or content feed that provides the entities the latest posts, articles, and/or updates from the entities' connections and/or groups. Similarly, online network 118 may include features or mechanisms for recommending connections, job postings, articles, and/or groups to the entities.

In one or more embodiments, data (e.g., data 1 122, data x 124) related to the entities' profiles and activities on online network 118 is aggregated into a data repository 134 for subsequent retrieval and use. For example, each profile update, profile view, connection, follow, post, comment, like, share, search, click, message, interaction with a group, address book interaction, response to a recommendation, purchase, and/or other action performed by an entity in online network 118 may be tracked and stored in a database, data warehouse, cloud storage, and/or other data-storage mechanism providing data repository 134.

In turn, member profiles, connections, and/or activity with online network 118 are used by a screening system 102 to conduct real or simulated interviews (e.g., interview 1 112, interview y 114) for jobs, positions, roles, and/or opportunities that are listed within or outside online network 118. For example, screening system 102 may allow candidates 116 for the jobs, positions, roles, and/or opportunities to prepare for job interviews by providing answers to “practice” interview questions. Screening system 102 may also allow mentors 110 that are connected to candidates 116 in online network 118 and/or that have skills, experience, and/or other qualifications for evaluating the answers to provide feedback related to the answers.

As shown in FIG. 1, mentors 110 and candidates 116 may be identified by an identification mechanism 108 using data from data repository 134 and/or online network 118. First, identification mechanism 108 may identify candidates 116 as users who have applied to jobs, positions, roles, and/or opportunities, within or outside online professional network 118. Identification mechanism 108 may also, or instead, identify candidates 116 as users and/or members of online professional network 118 with skills, work experience, and/or other attributes or qualifications that match the corresponding jobs, positions, roles, and/or opportunities.

Second, identification mechanism 108 may identify mentors 110 as members of online network 118 and/or other users who have registered and/or volunteered for mentorship roles. Mentors 110 may additionally or alternatively include users that are identified by identification mechanism 108 as having skills, experience, reputations, recommendations, and/or other qualifications for evaluating interview answers provided by candidates 116.

Identification mechanism 108 and/or another component of the system may also include functionality to obtain user input for specifying mentors 110, candidates 116, and/or other entities participating in interviews and/or interview preparation managed through screening system 102. For example, the component may include a user interface that allows a candidate to view available practice interviews and/or initiate a practice interview. In another example, the component may allow a candidate to select and/or identify one or more mentors 110 that can be contacted to provide feedback related to the candidate's answers to interview questions presented in screening system 102.

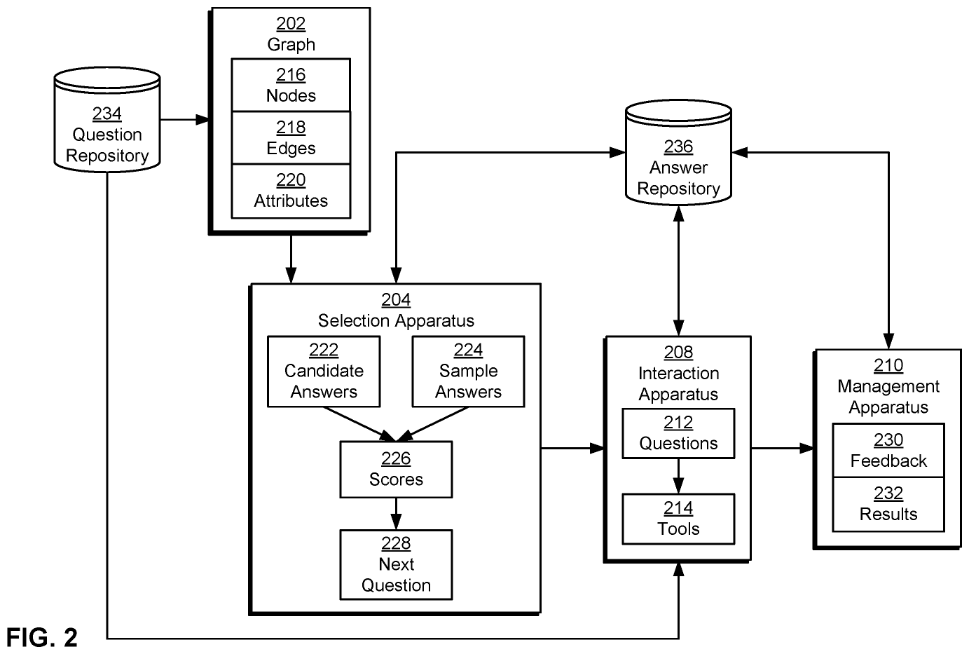

In one or more embodiments, screening system 102 performs adaptive interview preparation for candidates 116, in which interview questions are selected for presentation to candidates 116 based on the quality, content, correctness, tone, length, and/or other attributes of the candidates' answers to previous interview questions. As shown in FIG. 2, a system for performing adaptive interview preparation (e.g., screening system 102 of FIG. 1) may include a selection apparatus 204, an interaction apparatus 208, and a management apparatus 210. Each of these components is described in further detail below.

Interaction apparatus 208 displays and/or outputs a series of questions 212 in an interview, which can include an in-person interview, a phone interview, a practice interview, an assessment, and/or other type of scenario involving questioning of a candidate. For example, questions 212 may be used to simulate and/or conduct a behavioral interview, a software engineering interview (e.g., a coding interview), an engineering design interview, a case study interview, a learning assessment (e.g., a quiz or exam), and/or a skill assessment. A candidate and/or interviewer may provide input to interaction apparatus 208 to select an interview, view and/or answer questions 212 in the interview, and/or otherwise provide input and/or receive output related to interviewing functionality provided by the system.

Interaction apparatus 208 also provides tools 214 that assist candidates with preparing for and/or answering questions 212. For example, tools 214 may be used by the candidates to record audio and/or video; write, compile, and/or run code; and/or generate text-based input, drawings, and/or audio recordings. In another example, tools 214 may include tips and/or suggestions for preparing for an interview, guidelines for answering questions 212 in the interview, sample answers 224 to questions 212, and/or descriptions of the types of questions 212 encountered in the interview.

During an interview, interaction apparatus 208 may obtain a corresponding set of questions 212 from a question repository 234 and present a first question in the set to a user. After the user answers the first question, selection apparatus 204 may select a next question 228 to present to the candidate based on an answer (e.g., candidate answers 222) generated by the candidate in response to the first question. For example, selection apparatus 204 may select next question 228 based on the content, correctness, length, sentiment, tone, appropriateness, relevance, and/or other attributes of candidate answers 222 to one or more previous questions 212. Selection apparatus 204 may repeat the process of selecting a given next question 228 based on one or more candidate answers 222 to previous questions 212 encountered by the candidate until a certain number of questions 212 has been answered, a certain amount of time has lapsed, and/or another indication of the end of the interview or assessment has been reached.

In one or more embodiments, selection apparatus 204 uses a graph 202 of questions 212 to select and/or generate a sequence of questions 212 for a candidate. Graph 202 may be stored in question repository 234, in lieu of and/or in addition to other representations of questions 212 (e.g., database records, tables, spreadsheets, audio questions, video questions, etc.).

Graph 202 includes a set of nodes 216, a set of edges 218, and a set of attributes 220. Nodes 216 in graph 202 may represent questions 212 that can be presented in an interview, and edges 218 may represent potential combinations of questions 212 that can be selected by selection apparatus 204. For example, graph 202 may include a directed acyclic graph (DAG), with directed edges 218 in the DAG representing possible sequences of questions 212 that can be presented to a candidate. In other words, directed edges 218 from a node to a set of child nodes in the DAG may indicate that a question represented by the node can be followed by another question that is selected from a set of questions represented by the child nodes.

Nodes 216 and/or edges 218 may contain attributes 220 that describe the corresponding questions 212 and/or criteria related to selecting next question 228. For example, nodes 216 may include attributes 220 such as identifiers of the corresponding questions 212, the content of questions 212, and/or metadata related to questions 212 (e.g., tags, keywords, topics, question difficulties, question types, etc.). In another example, directed edges 218 between nodes 216 in a DAG may be represented as attributes 220 of nodes 216, with each parent node in the DAG containing a set of “child node” attributes that identify child nodes to which the node is connected via a set of edges 218. In a third example, edges 218 may include attributes 220 such as sample answers 224, different types of candidate answers 222, ranges of scores 226 calculated from candidate answers 222, and/or other criteria that can be used to select next question 228 based on candidate answers 222 to previous questions 212.

More specifically, selection apparatus 204 may identify a first question in an interview as a root and/or top-level node of graph 202 and transmit an identifier and/or representation of the first question to interaction apparatus 208 for display or presentation to the candidate. After the candidate provides a candidate answer to the first question through interaction apparatus 208, selection apparatus 204 may calculate a score (e.g., scores 226) for the answer based on the answer and/or sample answers 224 to the first question. Selection apparatus 204 may use the score and edges 218 between the root node and a set of child nodes 216 in graph 202 to select next question 228, and interaction apparatus 208 may present next question 228 to the candidate. Selection apparatus 204 may then repeat the process by selecting another next question 228 based on the candidate answers 222 to one or more of the most recently presented questions 212 until a leaf node in graph 202 and/or another indication of a final question in the interview is reached.

Selection apparatus 204 may additionally tailor selection of next question 228 based on the type of the candidate's answer to the current question, the availability and/or type of sample answers 224 to the current question, and/or other factors. When the current question is a multiple-choice question, selection apparatus 204 may match the candidate's answer to the question to an edge in graph 202 that represents the answer (e.g., an edge that represents a correct answer, an incorrect answer, and/or the candidate's actual answer). Selection apparatus 204 may then identify the child node connected to the edge and return the question represented by the child node as next question 228. Thus, next question 228 may reflect the correctness of the candidate's answer, the choice represented by the candidate's answer, and/or an estimate of the candidate's ability based on the candidate's answer and/or other candidate answers 222 from the candidate.

When the current question involves an answer that is received as freeform and/or semi-structured text (or video and/or audio that is converted into text), selection apparatus 204 may use similarities between the candidate's answer and sample answers 224 to the current question to select next question 228. Sample answers 224 may include curated answers that represent different categories of answers to the current question. For example, curated sample answers 224 may represent correct answers, incorrect answers, partially correct answers, complete answers, incomplete answers, appropriate answers, inappropriate answers, relevant answers, irrelevant answers, and/or other types of possible answers for the current question.

Sample answers 224 may also, or instead, include previous answers by other candidates to the same question. The previous answers may be collected during the same interview and/or similar interviews with the other candidates and/or from other interviewing platforms. As with curated sample answers 224, the previous answers may be tagged and/or categorized using attributes such as completeness, correctness, appropriateness, and/or relevance. After sample answers 224 are obtained as curated answers and/or previous answers from other candidates, sample answers 224 may be stored in an answer repository 236 for subsequent retrieval and use by selection apparatus 204 and/or other components of the system.

To compare the candidate's answer with one or more sets of sample answers 224, selection apparatus 204 may use natural language processing (NLP) techniques to generate a set of keywords, topics, sentiments, entities, word embeddings, metrics (e.g., word count, sentence count, average world length, etc.), and/or other features from the candidate's answer. Next, selection apparatus 204 may calculate a score containing a cosine similarity, Euclidean distance, cross product, and/or other representation of similarity between the candidate's answer and each sample answer. Selection apparatus 204 may also, or instead, input features associated with the candidate's answer into a machine learning model that has been trained using corresponding features from sample answers 224 and/or outcomes associated with follow-up questions to sample answers 224 (e.g., metrics representing correctness and/or timeliness of answers to the follow-up questions). In turn, the machine learning model may output one or more scores 226 that reflect and/or represent the similarities between the candidate's answer and sample answers 224.

Selection apparatus 204 may then use scores 226 to identify the sample answer with the highest score and/or similarity to the candidate's answer and select next question 228 as the child node in graph 202 that represents the sample answer. For example, selection apparatus 204 may obtain mappings of different sample answers 224 to child nodes 216 of the current question in graph 202 and select next question 228 as the child node to which the highest similarity sample question maps. As a result, next question 228 may be selected based on content, tone, subject matter, length, comprehensiveness, relevance, correctness, and/or other attributes or categories associated with sample answers 224 to which the candidate's answer was compared.

Selection apparatus 204 may also include functionality to calculate scores 226 for one or more candidate answers 222 and/or select next question 228 in the absence of sample answers 224 for the corresponding questions 212. For example, selection apparatus 204 may apply a set of rules and/or other evaluation criteria to the candidate's answer to a current question to produce one or more scores 226 representing the correctness, appropriateness, completeness, relevance, and/or another attribute of the answer. Selection apparatus 204 may then match the score(s) to a corresponding child node in graph 202 and select the question represented by the child node as next question 228.

When a score cannot be calculated for a candidate's answer and/or a score for the answer cannot be used to resolve next question 228, selection apparatus 204 may use graph 202 to identify a default next question 228 and select the default next question 228 for presentation to the candidate. For example, the default next question 228 may be stored as an attribute of a node representing the current question and/or an edge between the node and a child node. Selection apparatus 204 may return the default next question 228 for presentation to the candidate after the current question when the current question produces scores 226 that fall below a minimum threshold for similarity to sample answers 224, scores 226 do not match criteria for selecting any child nodes of the current question as next question 228, the candidate skips the current question, and/or next question 228 cannot be selected based on the content of the candidate's answer to the current question.

After the candidate has completed the interview, interaction apparatus 208, selection apparatus 204, and/or another component of the system may store candidate answers 222 in answer repository 236. In turn, management apparatus 210 may obtain and/or output feedback 230 related to candidate answers 222. For example, management apparatus 210 may include a user interface that allows the candidate to request feedback from one or more contacts (e.g., connections in an online network, colleagues, mentors, teachers, etc.). Within the user interface, the contacts may be ordered and/or ranked based on the candidate's relationship or familiarity with the contacts, the contacts' qualifications in providing feedback related to the interview, the contacts' willingness to provide interview feedback, and/or other criteria. After a contact is selected, management apparatus 210 may transmit the candidate's answers to one or more questions 212 to the contact, and the contact may provide a rating, review, and/or other type of feedback related to the answers within the user interface. Management interface 210 may then display, transmit, and/or otherwise output the feedback to the candidate, and the candidate may review the feedback as part of the candidate's interview preparation process.

Management apparatus 210 may also, or instead, output results 232 of the interview. For example, management apparatus 210 may aggregate scores 226 for individual candidate answers 222 into an overall score or rating representing the candidate's overall performance in the interview. Management apparatus 210 may also, or instead, display a score for each of the candidate's answers and/or for individual attributes of each answer (e.g., correctness, completeness, relevance, tone, appropriateness, etc.) to allow the candidate to distinguish areas in which the candidate has excelled from areas of improvement in the interview.

The candidate may choose to repeat the interview after reviewing feedback 230 and/or results 232 to further develop skills that are tested in the interview. When the candidate starts the interview, selection apparatus 204 may select the same first question and/or a different first question from graph 202. Selection apparatus 204 may then select a sequence of next questions based on the candidate's answers to previous questions in the interview. As a result, questions 212 presented to the candidate may change over time as the candidate develops and/or refines skills and/or strategies for answering questions 212. Question 212 may further be varied by including a randomization factor in selecting a given next question 228, in lieu of or in addition to selecting next question 228 based on candidate answers 222 to previous questions and/or the corresponding scores 226.

By adapting subsequent interview questions based on answers submitted by candidates for previous interview questions, the system of FIG. 2 may allow the candidates to practice interviewing at a level that fits the candidates' abilities and/or knowledge instead of at a level that is too hard or too easy. At the same time, the candidates may encounter new combinations of questions as the candidates retry the same interviews, which may improve the candidates' interviewing abilities and/or related skills and expose the candidates to different types of questions. In contrast, conventional interview preparation techniques may require all candidates to answer the same set of questions in a given practice interview and/or may select follow-up questions that are not based on the candidates' answers to previous questions. Consequently, the disclosed embodiments may improve the effectiveness, performance, and/or user experience associated with applications, computer systems, and/or technologies for performing interview preparation, candidate screening, recruiting, hiring, and/or assessment.

Those skilled in the art will appreciate that the system of FIG. 2 may be implemented in a variety of ways. First, selection apparatus 204, interaction apparatus 208, management apparatus 210, question repository 234, and answer repository 236 may be provided by a single physical machine, multiple computer systems, one or more virtual machines, a grid, one or more databases, one or more filesystems, and/or a cloud computing system. Selection apparatus 204, interaction apparatus 208, and management apparatus 210 may additionally be implemented together and/or separately by one or more hardware and/or software components and/or layers.

Second, the system of FIG. 2 may be adapted to various types of interviews, screenings, and/or interactions. For example, the functionality of the system may be used with real or practice interviews, screenings, auditions, exams, questionnaires, and/or other types of question-based interactions with applicants or candidates for academic positions, artistic or musical roles, school admissions, fellowships, scholarships, competitions, club or group memberships, matchmaking, research studies, and/or other types of opportunities.

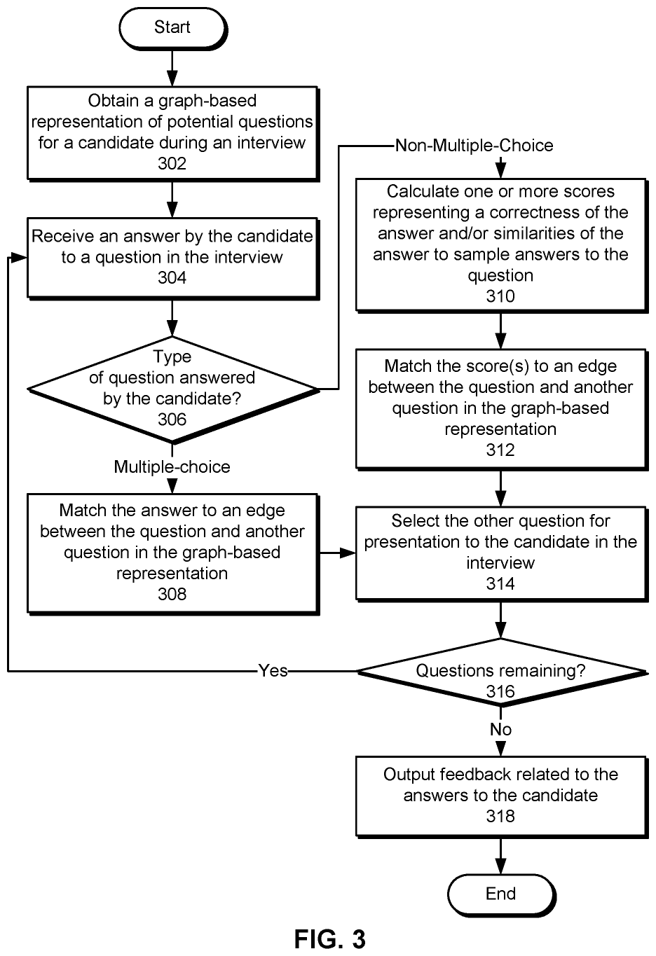

FIG. 3 shows a flowchart illustrating a process of performing adaptive interview preparation for a candidate in accordance with the disclosed embodiments. In one or more embodiments, one or more of the steps may be omitted, repeated, and/or performed in a different order. Accordingly, the specific arrangement of steps shown in FIG. 3 should not be construed as limiting the scope of the embodiments.

Initially, a graph-based representation of potential questions for a candidate during an interview is obtained (operation 302). For example, the graph-based representation may include a DAG that models possible paths and/or combinations of questions that can be presented to the user during the interview. The interview may include a real or practice version of a behavioral interview, software engineering interview, engineering design interview, case study interview, learning assessment, skill assessment, and/or other type of question-based interaction with the candidate.

Next, an answer by the candidate to a question in the interview is received (operation 304). For example, the first question in the interview may be selected as the root node of the DAG and/or from a set of possible root nodes in the DAG. After the candidate receives the first question, the candidate may generate and submit an answer to the first question.

A next question in the interview is then selected based on the type of question answered by the candidate (operation 306). If the question is a multiple-choice question, the answer is matched to an edge between the question and another question in the graph-based representation (operation 308), and the other question is selected for presentation to the candidate in the interview (operation 314). For example, each answer in the multiple-choice question may be mapped to a different child node of the question in the graph. In another example, the correct answer in the multiple-choice question may be mapped to one child node of the question in the graph, and remaining answers in the multiple-choice question may be mapped to another child node of the question in the graph. In both instances, the other question may be selected as the child node corresponding to the candidate's answer.

If the question is not a multiple-choice question (e.g., if the question involves a freeform or semi-structured answer), one or more scores representing a correctness of the answer and/or similarities of the answer to sample answers to the question are calculated (operation 310). For example, a set of keywords and/or features may be extracted from the answer, and a similarity score between the keywords and/or features and a corresponding set of keywords and/or features for a sample answer may be calculated. In another example, features for the answer may be inputted into a machine learning model, and one or more scores reflecting the similarities between the answer and the set of sample answers may be obtained as output from the machine learning model. In a third example, a score representing a correctness, completeness, relevance, tone, appropriateness, and/or other attribute of the answer may be calculated based on a set of rules and/or other evaluation criteria.

Next, the score(s) are matched to an edge between the question and another question in the graph-based representation (operation 312), and the other question is selected for presentation to the candidate in the interview (operation 314). For example, similarity scores between the answer and sample answers to the question may be used to identify a sample answer with the highest similarity to the answer, and the sample answer may be matched to a corresponding child node of the question in the graph-based representation. If none of the similarity scores meet a threshold for similarity between the answer and any sample answers, a default next question may be selected.

In another example, a score representing a correctness of the answer and/or the candidate's performance in the interview may be matched to a corresponding edge in the graph-based representation. A child node that is connected to the question via the edge may then be selected as the next question in the interview. Once a next question is selected for the candidate, presentation of the next question to the candidate is triggered (e.g., by transmitting an identifier and/or content for the next question to a user interface and/or displaying the question within the user interface).

Operations 304-314 may be repeated for remaining questions (operation 316) in the interview. For example, a next question may be selected based on the candidate's answer to the current question, scores calculated from the candidate's answer and/or sample answers to the question, and/or other criteria until a leaf node of the DAG is reached, a certain amount of time has passed, and/or another indication of the end of the interview is identified.

Finally, feedback related to the answers is outputted to the candidate (operation 318). For example, the candidate's answers may be transmitted to contacts, mentors, and/or connections of the candidate, and feedback related to the quality, correctness, and/or other attributes of the answers may be obtained from the contacts, mentors, and/or connections. The feedback may then be provided to the candidate to allow the candidate to assess his/her performance in the interview and/or improve the candidate's performance in subsequent interviews. In another example, scores for the answers and/or an overall score for the interview may be displayed to the candidate to facilitate subsequent studying and/or interview practice by the candidate.

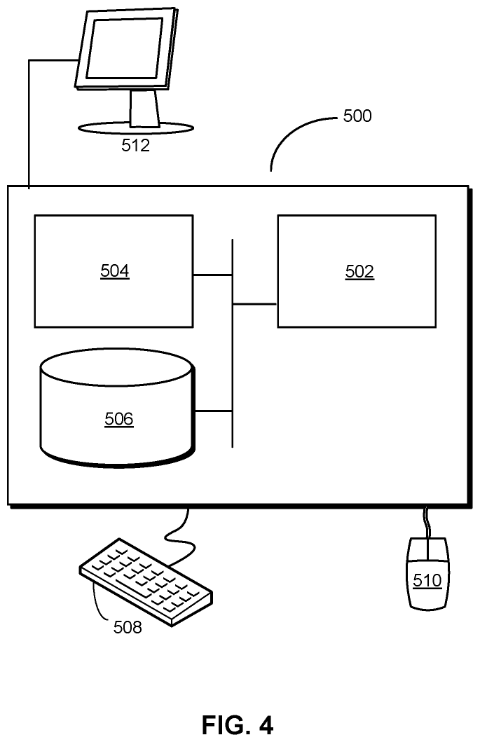

FIG. 4 shows a computer system 400 in accordance with the disclosed embodiments. Computer system 400 includes a processor 402, memory 404, storage 406, and/or other components found in electronic computing devices. Processor 402 may support parallel processing and/or multi-threaded operation with other processors in computer system 400. Computer system 400 may also include input/output (I/O) devices such as a keyboard 408, a mouse 410, and a display 412.

Computer system 400 may include functionality to execute various components of the present embodiments. In particular, computer system 400 may include an operating system (not shown) that coordinates the use of hardware and software resources on computer system 400, as well as one or more applications that perform specialized tasks for the user. To perform tasks for the user, applications may obtain the use of hardware resources on computer system 400 from the operating system, as well as interact with the user through a hardware and/or software framework provided by the operating system.

In one or more embodiments, computer system 400 provides a system for performing adaptive interview preparation for candidates. The system includes a selection apparatus, an interaction apparatus, and a management apparatus, one or more of which may alternatively be termed or implemented as a module, mechanism, or other type of system component. The selection apparatus obtains a graph-based representation of questions in an interview with a candidate. Next, the selection apparatus receives an answer by the candidate to a first question in the interview. The selection apparatus then calculates similarities between the answer and a set of sample answers to the first question and selects a second question for presentation to the candidate in the interview based on a highest similarity of the answer to a sample answer and an edge between the first and second questions in the graph-based representation. Finally, the interaction apparatus presents the second question to the candidate, and the management apparatus outputs feedback related to the answer to the candidate.

By configuring privacy controls or settings as they desire, members of a social network, a professional network, or other user community that may use or interact with embodiments described herein can control or restrict the information that is collected from them, the information that is provided to them, their interactions with such information and with other members, and/or how such information is used. Implementation of these embodiments is not intended to supersede or interfere with the members' privacy settings.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor (including a dedicated or shared processor core) that executes a particular software module or a piece of code at a particular time, and/or other programmable-logic devices now known or later developed. When the hardware modules or apparatus are activated, they perform the methods and processes included within them.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method, comprising:
obtaining a graph-based representation of potential questions for a candidate during an interview;
receiving, by a computer system, an answer by the candidate to a first question included in the graph-based representation of potential questions;
calculating, by the computer system, similarities between the answer and a set of sample answers to the first question;
selecting, by the computer system, a second question for presentation to the candidate in the interview based on a highest similarity of the answer to a sample answer in the set of sample answers and a first edge between the first and second questions in the graph-based representation; and
triggering presentation of the selected second question to the candidate.

2. The method of claim 1, further comprising:
receiving another answer by the candidate to a multiple-choice question in the interview;
matching the other answer to a second edge between the multiple-choice question and a third question in the graph-based representation; and
selecting the third question for presentation to the candidate in the interview.

3. The method of claim 1, further comprising:
calculating a score representing a correctness of another answer by the candidate to a third question in the interview;
matching the score to a second edge between the third question and a fourth question in the graph-based representation; and
selecting the fourth question for presentation to the candidate in the interview.

4. The method of claim 1, wherein calculating the similarities between the answer and the set of sample answers to the first question comprises:
inputting features for the answer into a machine learning model; and
receiving, as output from the machine learning model, one or more scores reflecting the similarities between the answer and the set of sample answers.

5. The method of claim 1, wherein calculating the similarities between the answer and the set of sample answers comprises:
extracting a set of keywords from the answer; and
calculating a similarity score between the set of keywords and another set of keywords for a sample answer.

6. The method of claim 1, wherein selecting the second question for presentation to the candidate in the interview comprises:
matching the sample answer associated with the highest similarity to an attribute associated with the first edge; and
selecting the second question based on the first edge between the first and second questions.

7. The method of claim 1, wherein selecting the second question for presentation to the candidate in the interview comprises:
when the highest similarity does not meet a threshold for similarity between the answer and the sample answer, selecting a default next question for the first question as the second question.

8. The method of claim 1, further comprising:
outputting feedback related to the answer to the candidate.

9. The method of claim 8, wherein the feedback comprises at least one of:
a score for the answer; and
user feedback.

10. The method of claim 1, wherein the graph-based representation comprises a directed acyclic graph (DAG).

11. The method of claim 1, wherein the set of sample answers comprises at least one of:
a curated answer; and
a previous answer by another candidate to the first question.

12. The method of claim 1, wherein the interview comprises at least one of:
a behavioral interview;
a software engineering interview;
an engineering design interview;
a case study interview;
a learning assessment; and
a skill assessment.

13. A system, comprising:
one or more processors; and
memory storing instructions that, when executed by the one or more processors, cause the system to:
obtain a graph-based representation of potential questions for a candidate during an interview;
receive an answer by the candidate to a first question included in the graph-based representation of potential questions;
calculate similarities between the answer and a set of sample answers to the first question;
select a second question for presentation to the candidate in the interview based on a highest similarity of the answer to a sample answer in the set of sample answers and a first edge between the first and second questions in the graph-based representation; and
trigger presentation of the selected second question to the candidate.

14. The system of claim 13, wherein the memory further stores instructions that, when executed by the one or more processors, cause the system to:
receive another answer by the candidate to a multiple-choice question in the interview;
match the other answer to a second edge between the multiple-choice question and a third question in the graph-based representation; and
select the third question for presentation to the candidate in the interview.

15. The system of claim 13, wherein the memory further stores instructions that, when executed by the one or more processors, cause the system to:
calculate a score representing a correctness of another answer by the candidate to a third question in the interview;
match the score to a second edge between the third question and a fourth question in the graph-based representation; and
select the fourth question for presentation to the candidate in the interview.

16. The system of claim 13, wherein calculating the similarities between the answer and the set of sample answers to the first question comprises:
inputting features for the answer into a machine learning model; and
receiving, as output from the machine learning model, one or more scores reflecting the similarities between the answer and the set of sample answers.

17. The system of claim 13, wherein calculating the similarities between the answer and the set of sample answers comprises:
extracting a set of keywords from the answer; and
calculating a similarity score between the set of keywords and another set of keywords for a sample answer.

18. The system of claim 13, wherein selecting the second question for presentation to the candidate in the interview comprises:
when the highest similarity does not meet a threshold for similarity between the answer and the sample answer, selecting a default next question for the first question as the second question.

19. The system of claim 13, wherein the set of sample answers comprises at least one of:
a curated answer; and
a previous answer by another candidate to the first question.

20. A non-transitory computer-readable storage medium storing instructions that when executed by a computer cause the computer to perform a method, the method comprising:
obtaining a graph-based representation of potential questions for a candidate during an interview;
receiving an answer by the candidate to a first question included in the graph-based representation of potential questions;
calculating similarities between the answer and a set of sample answers to the first question;
selecting a second question for presentation to the candidate in the interview based on a highest similarity of the answer to a sample answer in the set of sample answers and a first edge between the first and second questions in the graph-based representation; and
triggering presentation of the selected second question to the candidate.
